(19) United States
(12) Patent Application Publication
(10) Pub. No.: US 2007/0234908 A1
(43) Pub. Date: Oct. 11, 2007

(54) Multiple Baler System

(76) Inventors: James Hines, Hartsville, SC (US); John L. Newsome III, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/279,142

(22) Filed: Apr. 10, 2006

(51) Int. Cl. B30B 7/00

(52) U.S. Cl. 100/237; 100/269.01

(57) ABSTRACT

A multi-baler system includes at least a first baler and a second baler that are dimensioned and functionally configured for crushing and baling different respective materials such as cardboard and plastic. Movable platens forcibly extend and withdraw under the control of a programmable logic controller. Sensors detect the dispositions of doors, gates, and platens. A baler dedicated to baling plastic fully extends its platen to expel air from plastic materials in a baling compartment. Platens forcibly extend for the durations of extension time intervals as measured by the controller. Threshold sensors provide signals by which the controller discerns when a baler is full. A platen is maintained in an extended position as a bale is prepared.

### FIELD OF THE INVENTION

Embodiments of the present invention relate generally to baler systems for crushing and baling materials. More particularly, embodiments of the invention relate to a multi-baler system for crushing and baling multiple materials.

### BACKGROUND OF THE INVENTION

The recycling of cardboard has become conventionally integrated into many industries. For example, large retailers typically have baler systems for crushing and baling cardboard so that packing materials, which are typically by-products of their product transportation and distribution systems, can be conveniently volumetrically reduced, stored, and transported to recycling centers or otherwise disposed.

Plastic materials are becoming as ubiquitous as, and in some cases more prevalent than, cardboard materials. Some waste recycling and disposal systems are experiencing difficulties in managing plastic resources and wastes. In some cases, plastic materials are merely combined with cardboard and mixed-waste bales are prepared. However, cardboard and plastic waste materials are generally recycled by different processes and are often recycled at different facilities. In some cases, mixed waste bales are broken apart and separated into their constituent parts so the different materials can proceed toward disposal or recycling. Thus combining waste materials within a single bale can cause logistical inconveniences and needless expenses.

Furthermore, conventional balers are configured to crush cardboard. Cardboard is generally porous and generally readily expels any air contents when crushed. Structures such as cardboard boxes are typically permanently affected by crushing and typically don't recover their original shapes once crushing forces are removed. Plastic materials, on the other hand, tend to be relatively resilient and tend to trap air, which can be volumetrically reduced and then can re-expand. Also, typical conventional balers are dimensioned and configured to prepare bales that are so large that, even if a well-crushed plastic bale can be prepared, the plastic bale may be considerably heavier than a similarly dimensioned cardboard bale. Thus, entities handling large volumes of plastic materials are encountering difficulties when they try to bale plastic in conventional cardboard balers.

Therefore, a need exists for improvements toward volumetrically reducing and baling plastics. A need exists for a baling system that prepares conveniently sized plastic bales. A need exists for a baling system that defeats some of the resiliency of plastic materials and causes trapped air to be expelled from plastic materials as the materials are crushed.

### BRIEF SUMMARY OF THE INVENTION

Embodiments of the invention may address at least some of the above needs and achieve other advantages. For example, a first aspect of the invention relates to a multi-baler system having separate balers for cardboard and plastic materials. In the embodiments described herein, a unified control system motivates forcible movements of multiple balers. The different balers of the inventive multi-baler system optionally have different respective dimensions. Optionally, a programmable controller directs the movements of the multiple balers and may be programmed according to many configurations.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a frontal elevation view of a multi-baler system according to one or more embodiments of the present invention, shown with the gates and doors of the system closed;

FIG. 2 is a frontal elevation view of the baler system of FIG. 1; shown with the gates and doors of the system open;

FIG. 3 is a rear elevation view of the baler system of FIG. 1;

FIG. 4 is a left-side elevation view of the baler system of FIG. 1;

FIG. 5 is a right-side elevation view of the baler system of FIG. 1;

FIG. 6 is a top view of the baler system of FIG. 1;

FIG. 7 is a diagrammatic representation of an embodiment of a pressure control system for motivating the ram assemblies of the baler system of FIG. 1;

FIG. 8 is a diagrammatic representation of the pressure relief by-pass valve of the pressure control system of FIG. 7;

FIG. 9 is a diagrammatic representation of a director valve of the pressure control system of FIG. 7, showing the director valve disposed to extend a ram assembly;

FIG. 10 is a diagrammatic representation of a director valve of the pressure control system of FIG. 7, showing the director valve disposed to withdraw a ram assembly;

FIG. 11 is a diagrammatic representation of an embodiment of a pressure control system that is provided as an alternative to that of FIG. 7, which alternative embodiment may be particularly advantageous for adding an inventive second baler compartment to an existing single baler system;

FIG. 12 is a diagrammatic representation of a selector valve of the pressure control system of FIG. 11, showing the selector valve disposed to select the second ram assembly; and

FIG. 13 is a diagrammatic representation of an embodiment of an electrical system for electrically actuating and controlling the pressure control system of FIG. 7.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

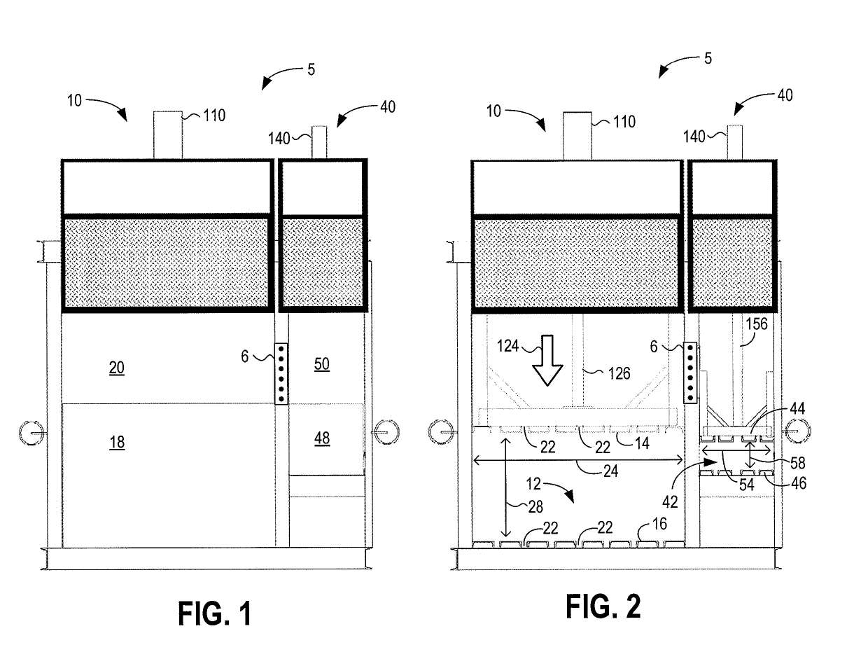

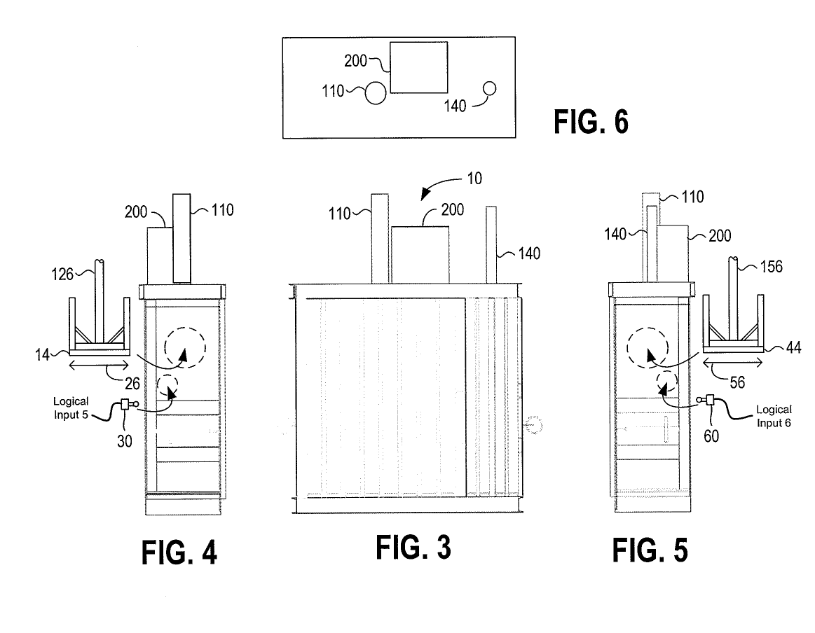

An embodiment of a multi-baler system 5 according to the present invention is illustrated in FIGS. 1-6. The multi-baler system 5 includes a first baler 10 that comprises a first baling compartment 12 defined between a movable first upper platen 14 and a fixed first lower platen or floor 16 that opposes the upper platen. A first ram assembly 110 is motivated by a pressure control system 200 (FIG. 3) to forcibly extend and withdraw a first ram shaft 126. The first platen 14 is connected to and travels with the first ram shaft. Thus, as the first ram shaft forcibly extends along the extension direction 124, the first platen 14 forcibly approaches the first floor 16, which approach diminishes the distance 28 between the first platen and the floor and volumetrically diminishes the first baling compartment accordingly. As the first ram shaft withdraws, the first platen raises away from the first floor. The first platen is generally fully raised when the first baling compartment is to be loaded with material and is generally lowered when the loaded material is to be crushed. The platen may be lowered and raised several times before the compartment is filled with crushed material. The platen is maintained at a lowered position as crushed material is baled. In FIG. 2, the first ram shaft is at least partially extended, and thus the first platen 14 is shown at a lowered position.

Access to the first baling compartment 12 is blocked in FIG. 1 by a lower first door 18 and an upper first gate 20. The lower door blocks frontal access to the portion of the first baling compartment 12 (FIG. 1) below the lowered first platen 14. The lower door generally remains closed until crushed material is to be secured with wire and removed from the first baling compartment. The lower door pivots about a hinge when opened, and swings outward from the baler system 5. The upper gate 20 is generally open when the platen is fully raised so that material may be loaded into the first baling compartment by lifting the material over the door 18 and dropping the material toward the floor 16 of the compartment. The upper gate 20 is generally closed as the platen is being lowered in order to trap material being crushed. The first upper gate 20 is raised when opened, and is lowered when closed to abut or nearly abut the first lower door 18. For convenience, the first upper gate 20 is raised automatically as the first platen is raised so that material may be loaded into the first baling compartment. The first upper gate and first lower door may be opened and closed independently of each other.

The multi-baler system 5 further includes a second baler 40 that comprises a second baling compartment 42 defined between a movable second upper platen 44 and a fixed second lower platen or floor 46 that opposes the upper platen. A second ram assembly 140 forcibly extends and withdraws a second ram shaft 156. The second platen 44 is connected to and travels with the second ram shaft. Thus, as the second ram shaft forcibly extends along the extension direction 124, the second platen 44 forcibly approaches the first floor 46, which approach diminishes the distance 58 between the second platen and the floor and volumetrically diminishes the second baling compartment accordingly. In FIG. 2, the second ram shaft is at least partially extended, and thus the second platen 44 is shown at a lowered position.

Access to the second baling compartment 42 is blocked in FIG. 1 by a lower second door 48 and an upper second gate 50. The lower door blocks frontal access to the lower portion of the second baling compartment 42 (FIG. 1). The lower door generally remains closed until crushed material is to be secured with wire and removed from the second baling compartment. The upper gate 50 is generally open when the platen is fully raised for loading of the baling compartment. The lower door pivots about a hinge when opened, and swings outward from the baler system 5. The upper gate 50 is generally closed as the platen is to being lowered. The upper gate 50 pivots about a hinge when opened, and swings outward from the baler system somewhat like a raised cupboard door. Therefore, for the safety of an operator, the upper gate 50 is not automatically opened as the second platen is raised. The upper gate is mechanically prevented from closing unless the lower door is already closed. Therefore, closure of the second upper gate assures closure of the second lower door.

Nominal internal lengths are prescribed for the balers by the lengths of the platens and baling chambers as viewed in FIG. 2. The first platen has a length 24 and the second platen has a length 54. A nominal width for each baler is prescribed by the widths of the platens and chambers according to the perspectives of FIGS. 4 and 5. The first platen 14 has a width 26 and the second platen 44 has a width 56. The heights of the baling compartments are variable according the respective positions of the movable platens shown in FIG. 2. The variable height of the first baling compartment corresponds to the distance 28 between the first platen 14 and first floor 16. The variable height of the second baling compartment corresponds to the distance 58 between the second platen 44 and second floor 46. Each movable platen has a surface area for abutting and crushing material. The surface area of a platen is defined as the product of the length and width of the platen. That is, the surface area of the first platen is defined by the product of the length 24 and the width 26, and the surface area of the second platen is defined by the product of the length 54 and the width 56.

With regard to both the first baler 10 and the second baler 40, when the baling compartment is appropriately full of crushed material, the platen is generally maintained in a lowered position such as that shown in FIG. 2, which may not be drawn to scale, so that baling wire or other tensionable binding material can be wrapped around the crushed material to prepare a bound bale that can be transported as a unit. The lower door is generally manually opened without movement of the platen for the preparation of the bale. Channels 22 are formed in the platen 14 and floor 16 so that baling wire may be passed about crushed material. Optionally, a cable or other member lifts and ejects a wrapped bale from the baling compartment for the convenience of an operator as the platen is raised.

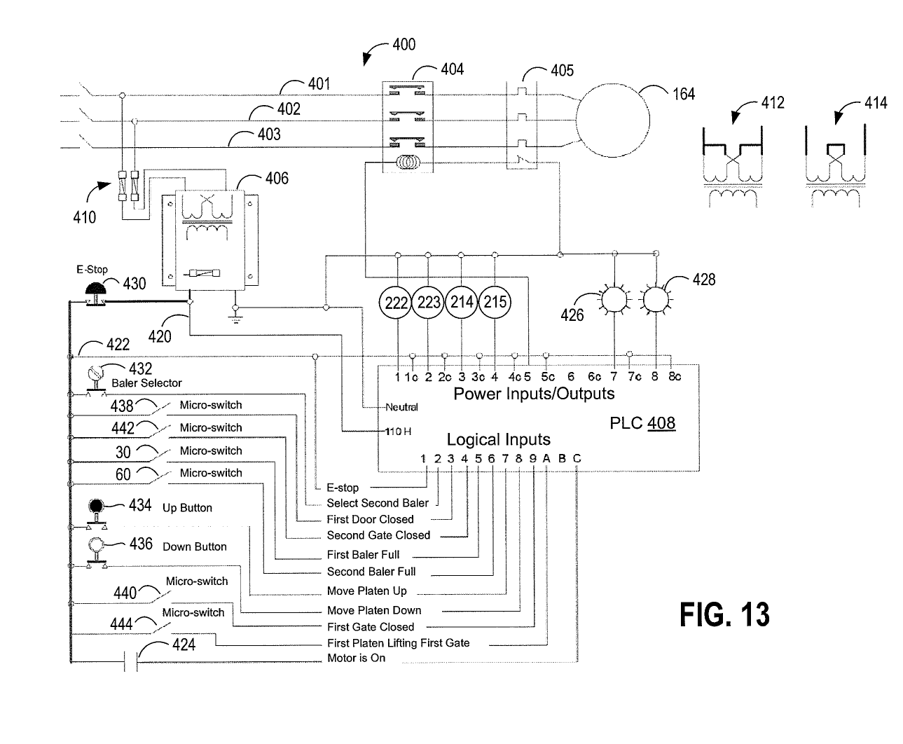

The multi-baler system 5 includes an array 6 of control elements and status indicators so that an operator may control the system and be informed of its status. The control elements and status indicators are described in further detail with reference to electrical system 400 of FIG. 13. The array 6 is shown mounted on the frontal side of the multi-baler system between the first and second balers in FIGS. 1 and 2, although other placements and arrangements of the array are within the scope of these descriptions.

The extended positions of the platens are described herein as vertically lowered, and the withdrawn positions of the platens are described herein as vertically raised. Similarly, the movements of the platens may be described herein as raising and lowering movements. Such terms relating to vertical dispositions and movements are used herein merely to provide detailed descriptions of particular embodiments of the invention. These descriptions nonetheless relate to baler systems exhibiting movements along axes having any desired physical orientation. Thus, while the multi-baler system 5 as described herein includes platens that move vertically, other embodiments of multi-baler systems according to the invention include platens that move along axes that are not vertical. For example, at least one inventive embodiment includes horizontally moving platens, and, at least one other inventive embodiment includes a first platen exhibiting vertical motion and a second platen exhibiting horizontal motion.

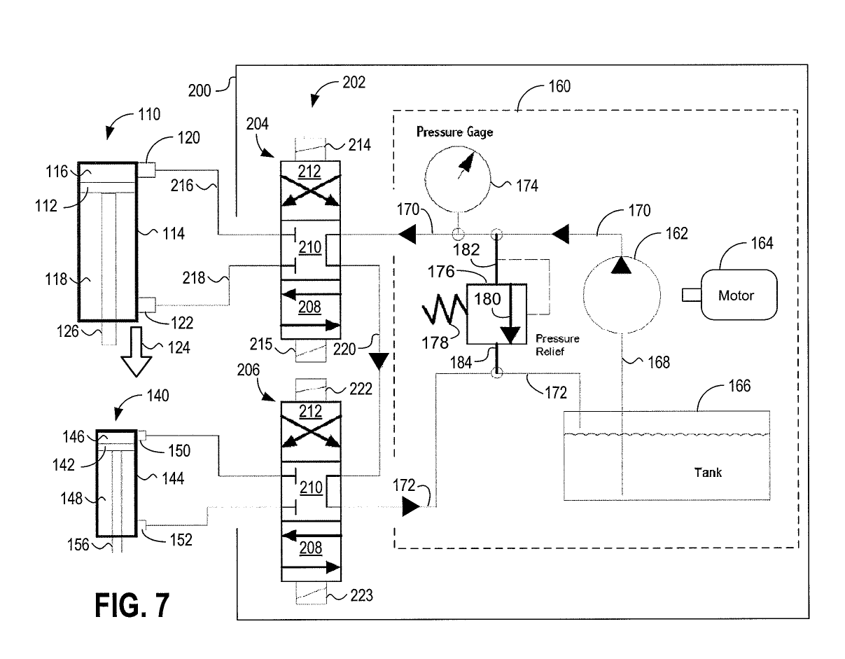

The previous descriptions entail similarities between the first and second balers. Nonetheless, according to at least one particular embodiment of the multi-baler system 5, the two balers are dimensioned and configured for baling different respective materials, namely cardboard and plastic. Indeed, many advantages toward dedicating the first and second balers to the baling of different respective materials and many advantages toward safety are provide by the inventive multi-baler system 5. These advantages and the means by which each is provided may best be understood in view of the pressure control system 200 (FIG. 7), which motivates movements of the platens, and in view of the electrical system 400 (FIG. 13), which controls and actuates the pressure control system. For now, note that various sensors, such as micro-switches, monitor the dispositions of various components of the multi-baler system, that these sensors facilitate various automatic safety and performance advantages of the baler system, and that dimensional and operational differences between the two balers will be described in the context of at least one particular embodiment of the baler system 5.

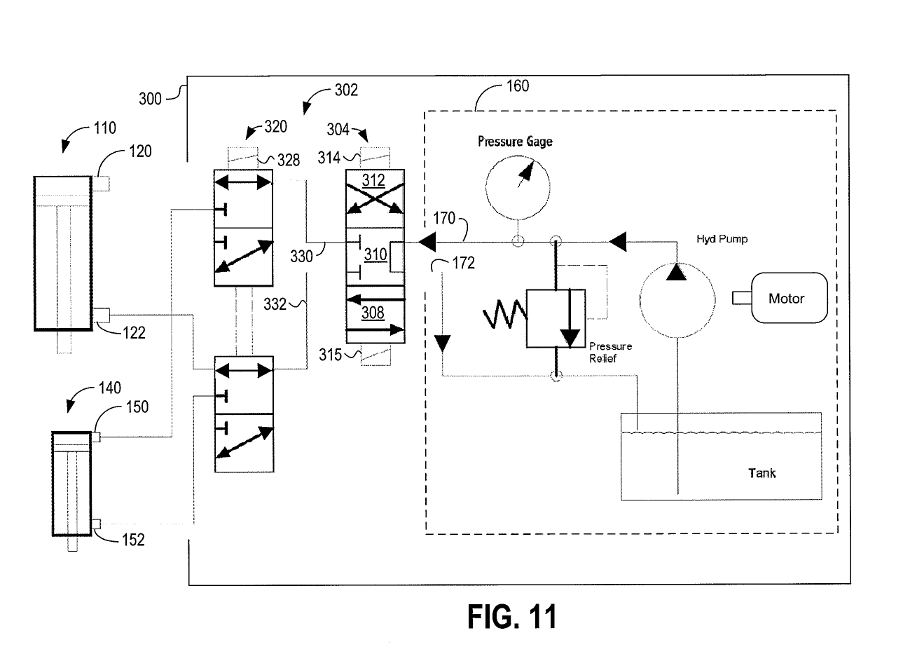

An exemplary embodiment of a pressure control system 200 is diagrammatically shown in FIG. 7. An alternative exemplary embodiment of a pressure control system 300 is diagrammatically shown in FIG. 11. These two systems bear similarities with regard to their fluid pumping systems, and bear differences with regard to their fluid manifold systems. Either of these two pressure control systems can be included in the multi-baler system of FIGS. 1-6. Generally speaking, the fluid pumping system 160 provides pressurized fluid to the fluid manifold systems 202 (FIG. 7) and 302 (FIG. 11), and the fluid manifold systems direct the pressurized fluid to the first and second ram assemblies 110 and 140 to actuate their movements. In the following descriptions, the pumping system and the ram assemblies will be described prior to descriptions of the alternative manifold systems 202 and 302. It should be understood that the descriptions herein of the fluid pumping system and the descriptions herein of the ram assemblies, which descriptions are first provided with reference to FIG. 7, relate equally to FIGS. 7 and 11.

With regard to the fluid pumping system 160, as shown in FIG. 7, the system 160 comprises a fluid pump 162 that is controllably driven by a motor 164 to pump fluid from a reservoir tank 166 along a fluid conduit line 168. The pump pressurizes the fluid and compels movement of the fluid into the first and second ram assemblies by way of a fluid manifold system 202. The fluid conduit line 170 is disposed directly upstream of the manifold system 202 and delivers pressurized fluid from the pump to the manifold system for further distribution to the ram assemblies. Therefore the fluid conduit line 170 may be described as linked to the P-side of the manifold system with reference to the pressure generated by the pump, and the line 170 may be referred to as the P-line. The fluid conduit line 172 is disposed directly downstream of the manifold system and routes fluid from the manifold system to the tank. Therefore the fluid conduit line 172 may be described as linked to the T-side of the manifold system with reference to the tank, and the line 172 may be referred to as the T-line. Optionally, a pressure gage 174 indicates the pressure of the P-line 170.

In the descriptions herein, fluid relates to relatively incompressible hydraulic fluids such as mineral oil, organophosphate ester, polyalphaolefin, and other fluids based on glycol esters, ethers, castor oil, and silicone. Additionally, the term fluid as used herein relates to air and other compressible gases. Thus, these descriptions relate to hydraulic (liquid) fluid systems and to pneumatic systems.

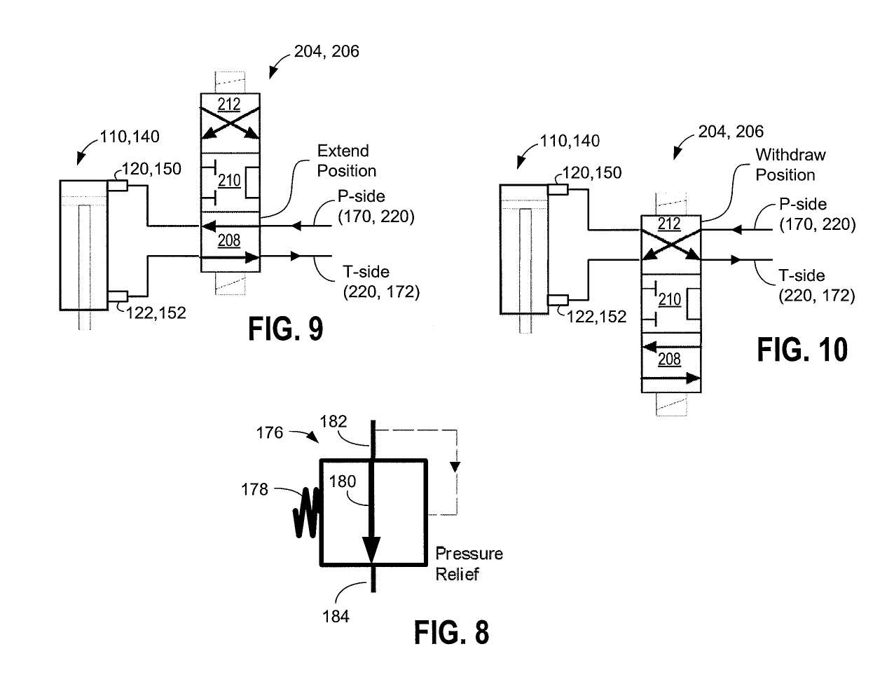

A pressure relief apparatus 176 links the P-line 170 to the T-line 172 in FIG. 7. It actuates to bypass the manifold system 202 in the event that over-pressurization in the P-line occurs. A force derived within the pressure relief apparatus from the pressure in the P-line opposes the force of a spring 178. If the fluid pressure within the P-line exceeds a preset value, the apparatus actuates to assume its bypass position as diagrammatically shown in FIG. 8, wherein a fluid channel defined by a movable valve member 180 aligns with fluid conduit lines 182 and 184 and allows fluid to be released from the P-line to the reservoir tank 166 by way of the T-line. The fluid pump and motor are generally capable of generating high fluid pressures, for example they may be capable of producing pressures in excess of thirty-five hundred pounds per square inch of fluid pressure. Thus, the pressure relief apparatus protects the various lines, couplings, seals, valves, and ram assemblies of the multi-baler system. Furthermore, as described below with reference to the ram assemblies, actuation of the pressure relief apparatus toward by-passing the manifold system 202 is expected with each full extension of a ram assembly.

With regard to the ram assemblies, in FIG. 7, the first ram assembly 110 includes a piston 112 movable within a cylinder 114. The interior of the cylinder is subdivided into a variable extension chamber 116 and a variable withdrawal chamber 118, which are defined on opposing sides of the piston 112. The extension and withdrawal chambers are linked to the system 200 by way of extend and withdraw ports 120 and 122, respectively. Each port operates as a two-way conduit for pressurized fluid in that fluid both enters and exits the extension and withdrawal chambers of the cylinder by way of the respective ports 120 and 122.

Regarding extension of the first ram assembly 110, when the system 200 injects pressurized fluid into the extension chamber 116 by way of the extend port 120, and allows the release of fluid from the withdrawal chamber 118 by way of the withdraw port 122, the volume of the extension chamber expands by movement of the piston in the extension direction 124 relative to the cylinder 114. This forcibly lowers the first platen. The ram assembly may reach full extension. At full extension of the ram assembly, the piston and ram shaft are retained by the cylinder such that further movement of the piston in the extension direction is mechanically arrested. This blocks the further flow of fluid into the extension chamber and may cause the pressure relief apparatus to be actuated (FIG. 8) toward by-passing the manifold system 202 (FIG. 7).

Regarding withdrawal of the first ram assembly 110, when the system 200 injects pressurized fluid into the withdrawal chamber 118 by way of the withdraw port 122, and allows the release of fluid from the extension chamber 116 by way of the extend port 120, the volume of the withdrawal chamber expands by movement of the piston in a direction opposite the extension direction 124. This raises the first platen 14 (FIG. 2).

The second ram assembly 140 is extended and withdrawn somewhat like the first ram assembly. In view of FIG. 7, when the system 200 injects pressurized fluid into the extension chamber 146 by way of the extend port 150, and allows the release of fluid from the withdrawal chamber 148 by way of the withdraw port 152, the piston moves in the extension direction 124. This forcibly lowers the second platen. At full extension of the second ram assembly, the pressure relief apparatus may be actuated (FIG. 8) toward by-passing the manifold system 202 FIG. 7. The second ram assembly is withdrawn, and the second platen is raised, when the system 200 injects pressurized fluid into the withdrawal chamber 148 by way of the withdraw port 152, and allows the release of fluid from the extension chamber 146 by way of the extend port 150.

As previously stated, the descriptions herein of the fluid pumping system and the descriptions herein of the ram assemblies relate equally to FIGS. 7 and 11. The exemplary pressure control systems of FIGS. 7 and 11, however, do differ at least with regard to their respective fluid manifold systems. In FIG. 7, the fluid manifold system 202 includes a pair of three-position fluid valves 204 and 206, which are electrically actuatable. A first director valve 204 is generally dedicated to directing movements of the first ram assembly 110, and a second director valve 206 is generally dedicated to directing movements of the second ram assembly 140. Each of these director valves can assume one of three positions, namely an extend position 208, a neutral position 210, and a withdraw position 212. The first director valve 204 is electrically actuated by way of opposing solenoid circuits 214 and 215, or other motivating elements. The solenoid circuits 214 and 215 are alternatingly energized to compel the valve to assume its extend and withdraw positions 208 and 212 respectively. They are alternatingly energized in that they generally are not energized simultaneously. Similarly, the second director valve 206 is alternatingly compelled to assume its extend and withdraw positions 208 and 212 when the solenoid circuits 222 and 223 are respectively energized.

When a director valve assumes its neutral position, fluid conduit lines disposing the valve into fluid communication with its associated ram assembly are terminated at the valve. This isolates the ram assembly and arrests its movements. With regard to the first ram assembly 110, a fluid conduit line 216 linking the extend port 120 to the valve, and a fluid conduit line 218 linking the withdraw port 122 to the valve, are each terminated in FIG. 7 at the valve and movements of the first ram assembly are thereby resisted by the respective static fluid contents of the extension and withdrawal chambers 116 and 118 because the first director valve 204 assumes its neutral position 210 in FIG. 7. Similarly, the second ram assembly 140 is arrested when the second director valve assumes is neutral position 210 as illustrated in FIG. 7, wherein lines disposing the ports 150 and 152 into fluid communication with the valve 206 are terminated at the valve. Thus, in the configuration shown in FIG. 7, even if the motor 164 is activated to drive the pump 162, fluid merely circulates from the reservoir, along the P-line 170, through the first director valve 210, along the intermediate line 220, through second director valve 206, along the T-line 172, and returns to the tank, all without movement of either ram assembly. Each director valve described herein is mechanically biased toward and assumes its neutral position when its solenoid circuits are not energized or in the event its solenoid circuits fail. This safety feature is included at least in the valves 204 and 206 of FIG. 7, and in the valve 304 of FIG. 11.

The role of the director valves in directing the ram assemblies to extend and withdraw are respectively illustrated in FIGS. 9 and 10, which relate equally to the first director valve 204 and to the second director valve 206. FIG. 9 diagrammatically represents a director valve assuming its extend position 208, and FIG. 10 diagrammatically represents a director valve assuming its withdraw position 212. The P-line 170 of FIG. 7 is disposed directly upstream of the first director valve 204, and the intermediate line 220 disposed directly downstream of the valve, are respectively represented as the P-side and T-side when FIGS. 9 and 10 are related to the first director valve 204 and the first ram assembly 1 10. Similarly, the intermediate line 220 and the T-line 172, which are disposed directly upstream and downstream of the second director valve 206 in FIG. 7, are represented respectively as the P-side and T-side when FIGS. 9 and 10 are related to the second director valve 206 and the second ram assembly 140.

Regarding FIG. 9, when the director valve assumes its extend position 208, pressurized fluid pressure is routed through the valve from the P-side to the extend port (120, 150) of the ram assembly. Fluid is concurrently permitted to be released from the withdraw port (122 152), through the valve, and along the T-side. Thus, extension of the ram assembly (110, 140) can be provoked when the director valve (204, 206) assumes its extend position 208.

Conversely in FIG. 10, when the director valve assumes its withdraw position 212, pressurized fluid is routed through the valve from the P-side to the withdraw port (122, 152) of the ram assembly. Fluid is concurrently permitted to be released from the extend port (120, 150), through the valve, and along the T-side. Thus, withdrawal of the ram assembly (110, 140) can be provoked when the director valve (204, 206) assumes its extend position 208. In view of FIGS. 7-10, is should be understood that movements of the ram assemblies can be electrically controlled by energizing the motor 164 and actuating the solenoid circuits 214, 215, 222, and 223.

In FIG. 11, a pressure control system 300 is illustrated as an alternative to the pressure control system 200 of FIG. 7. The pressure control system 300 is linked by way of fluid conduit lines to the first and second ram assemblies 110 and 140. The ram assemblies have already been described with reference to FIG. 7. Furthermore, the pressure control system 300 includes the fluid pumping system 160, which was also already described with reference to FIG. 7. However, the fluid manifold system 302 of the pressure control system 300 of FIG. 11 is different from the fluid manifold system 202 of FIG. 7.

In particular, the fluid manifold system 302 includes a three-position director valve 304, and a two-position selector valve 320, which are electrically actuatable. The director valve 304 is dedicated to directing the extension and withdrawal movements of either ram assembly and the selector valve 320 is dedicated to selecting which ram assembly is tentatively directed by the director valve. The director valve 304 may assume an extend position 308, a neutral position 310, and a withdraw position 312. The position of the director valve may be electrically actuated by way of solenoid circuits 314 and 315, or other actuatable motivating elements. When the director valve assumes the extend position 308, the fluid conduit line 330 is defined as the upstream P-side of the selector valve 320 and the fluid conduit line 332 is defined as the downstream T-side. This arrangement motivates extension of either the first or second ram assembly according the disposition of the selector valve 320. Conversely, when the director valve assumes the withdraw position 312, the line 332 is defined as the P-side and the line 330 is defined as the T-side relative to the selector valve 320. This arrangement motivates the withdrawal of either the first or second ram assembly. When the director valve assumes the neutral position, movements of the ram assemblies are arrested.

The selector valve 320 is dedicated to selecting which ram assembly is tentatively directed by the director valve. The selector valve is electrically controlled by way of an electrically actuatable solenoid circuit 328 or other actuatable motivating element. The two-position selector valve 320 selects the first ram assembly 110 in FIG. 11, wherein the extend port 120 of the first ram assembly 110 is linked to the director valve 304 by way of the selector valve and the fluid conduit line 330. The withdraw port 122 of the first ram assembly is linked to the director valve 304 by way of the selector valve and the fluid conduit line 332. The extend port 150 and withdraw port 152 of the second ram assembly 140, however, are terminated at the selector valve in FIG. 11. Thus, in the position of the selector valve shown in FIG. 11, the second ram assembly is arrested while the first ram assembly can be extended, arrested, and withdrawn as the director valve 304 respectively assumes the extend, neutral, and withdraw positions 308, 310, and 312.

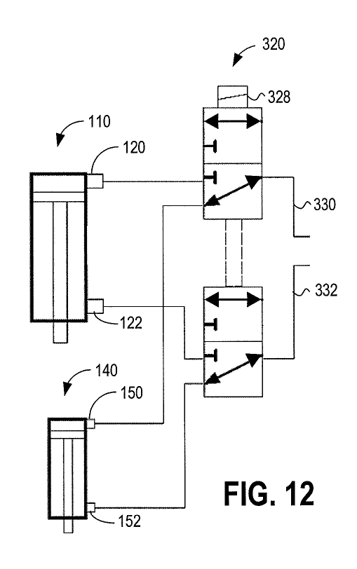

The two-position selector valve 320 selects the second ram assembly in FIG. 12, wherein the extend port 150 and withdraw port 152 of the second ram assembly 140 are linked to the director valve 304 by way of the selector valve. The ports 120 and 122 of the first ram assembly 110, however, are terminated at the selector valve in FIG. 12. Thus, when the selector valve assumes the position shown in FIG. 12, the first ram assembly is arrested while the second ram assembly can be extended, arrested, and withdrawn as the director valve 304 (FIG. 11) respectively assumes the extend, neutral, and withdraw positions 308, 310, and 312.

The pressure control system 300 of FIG. 11 may be particularly advantageous in a scenario where a single baler system is to be modified to become a multi-baler system according to the invention. Such a single baler system might originally include a fluid pumping system, a director valve, and a first ram assembly. By adding the selector valve 320 and a second ram assembly to such a single compartment baler system, along with other minor components and ancillary lines, a multi-baler system according to the invention can be effected without needless and expensive duplication of major components such as a fluid pumping system.

An exemplary electrical system 400, by which the fluid pumping system and fluid manifold system of FIGS. 1-10 can be electrically energized, controlled, and actuated, is schematically represented in FIG. 13. Electrical power is provided to the system 400 by way of three incoming power lines 401, 402, and 403 which respectively represent conventional hot, neutral, and ground lines. The motor 164, which motivates the fluid pump 162 of FIG. 7, receives electrical power by way of the incoming lines and the electrically actuatable contactor 404 and overload relay 405. It is expected that electrical power will be provided by alternating current along the incoming lines in either of two conventional voltage ranges, namely the 220 to 230 volts and the 440 to 460 volts ranges, although other electrical power conventions are within the scope of these descriptions. The motor 164 is configurable to receive power in either of these two ranges. A transformer 406 is electrically disposed between the incoming lines and a programmable logic controller (PLC) 408. Fuses 410 precede and protect the transformer and PLC from power surges and excessive currents. It is expected that the transformer outputs electrical power in the conventional 110 to 115 volts range, although other electrical power conventions are within the scope of these descriptions. Exemplary wiring schemes 412 and 414 for the transformer are schematically represented peripherally in FIG. 13 for transforming incoming power along the incoming power lines to the conventional 110 to 115 volts range. The scheme 412 is shown for transforming the 220 to 230 volts range, and the scheme is shown for transforming the 440 to 460 volts range. The transformer directly provides operating power to the PLC along a line 420. The transformer provides power for electrically actuating the contactor 408 and various valves of the baler system along the line 422. An emergency stop switch, represented as the E-Stop button 430 in FIG. 13, is electrically disposed between the transformer and the line 422.

Electrical power provided along the line 422 is routed to the power-needing components of the pressure control system 200 (FIG. 7) through the PLC 408 of FIG. 13. For example, along the array of power inputs and outputs of the PLC, electrical current passes through the PLC from the power input 1c to the power output 1 and on to the solenoid circuit 222 in order to compel the second director valve 206 (FIG. 7) to assume its extend position 208 when the platen of the second baler is to be lowered by extension of the second ram assembly. Similarly, the power input 2c of the PLC is associated with the power output 2 and the solenoid circuit 223 for withdrawing the second ram assembly. Furthermore, the power input 3c is associated with the power output 3 and solenoid circuit 214 for extending the first ram assembly, and the power input 4c is associated with the power output 4 for withdrawing the first ram assembly. The power input 5c is associated with the power output 5 for electrically actuating the contactor 404 to energize the motor 164. The overload relay 405 disrupts power to the contactor 404, thereby stopping power to the motor 164, if excessive electrical current is drawn by the motor.

Each power input of the PLC in FIG. 13, such as power input 1c, is controllably disposed in electrical communication with its associated power output, such as power output 1, according to the programming of the PLC which functionally relies on signals received by the PLC along the array of logical inputs. The logical inputs are derived from various sensors and control switches of the baler system. The sensors and control switches provide indicative signals to the logical inputs of the PLC in order for the PLC to discern the status of the sensors and switches. As described herein, an indicative signal relates equally to a closed circuit and to an open circuit. Furthermore, an indicative signal can entail, in both alternating current (AC) and direct current (DC) regimes: an electrical current; an electrical voltage level above or below ground; a lack of an electrical current; a grounded voltage level; and any other electrical, magnetic, or mechanical condition or convention by which the status of a switch or sensor can be discerned.

With particular regard to control switches, the logical input 1 of the PLC provides a signal indicating the status of a particular control switch, namely the E-Stop button 430. The logical input 2 provides a signal indicating the status of another control switch, namely the Baler Selector switch 432 by which an operator exclusively selects operation of either one of the first ram assembly and second ram assembly for use of the first or second baler respectively. Either ram assembly is exclusively selectable in that only one ram assembly may be selected at a time. The logical input 7 provides a signal indicating the status of yet another control switch, namely the Up Button 434 by which an operator provokes the withdrawal of the selected ram assembly when a platen is to be raised. The logical input 8 provides a signal indicating the status of a fourth control switch, namely the Down Button 436 by which an operator provokes the extension of the selected ram assembly when a platen is to be lowered in order to crush or bale material. The E-Stop button, the Baler Selector switch, the Up Button, and the Down Button may be disposed along the array 6 of FIGS. 1 and 2 for convenient access by an operator.

Several sensors are diagrammatically represented as micro-switches in FIG. 13. Each of these sensors is generally sensitive to the disposition or status of a particular component of the baler system 10 (FIGS. 1 and 2). Each micro-switch optionally comprises a spring biased arm disposed to contact a particular component when that component reaches or exceeds a critical disposition or threshold position. Movement of the mechanical arm generally actuates the micro-switch by causing the opening or closing of an electrical circuit and so the arrival of a component to a particular disposition can be electrically detected. Thus, sensors are described herein as providing signals indicative of dispositions or states of components of the baler system. Micro-switches, other types of sensors, and circuit elements by which the status of a component can be indicated are within the scope of these descriptions. For example, the logical input C of the PLC 408 provides a signal indicative of whether the motor 164 is energized according to a circuit element that is associated with or integral to the motor as diagrammatically represented in FIG. 13 by the sensor 424.

Furthermore, several micro-switches provide signals indicative of the closures of the gates and doors of the inventive multi-baler system. In particular, the logical input 3 provides a signal indicative of the closure of the first lower door 18 of FIG. 1 according to a micro-switch 438 functionally disposed in the closure path of the door. The logical input 9 provides a signal indicative of the closure of the first upper gate 20 according to a micro-switch 440 functionally disposed in the path of the gate. The logical input 4 provides a signal indicative of the closure of the second upper gate 50 according to a micro-switch 442 functionally disposed in the path of the gate. As previously stated, closure of the second upper gate assures closure of the second lower door 48, and thus the single micro-switch 442 provides a signal indicative of closure of the second baler. The PLC lights an indicator 428 when the door and gate of the selected baler are fully closed. The indicator 428 may be disposed along the array 6 of FIGS. 1 and 2 for convenient observance by an operator.

Recall that as the first platen 14 (FIG. 2) is raised, the first upper gate 20 (FIG. 1) is automatically raised in concert with the platen so that the first baling compartment may be loaded with material. Accordingly, the logical input A in FIG. 13 provides a signal indicative that the upper gate is being lifted by the raising of the platen according to a micro-switch 444 that is actuated as the first platen, or other member traveling with the first ram shaft, contacts and raises the first upper gate. Thus, the PLC 408 is provided a signal at the logical input A that distinguishes the automatic lifting of the first gate from a potentially dangerous situation wherein an unwary or unwise operator manually lifts the gate while the platen is in motion.

Sensors such as micros-witches are disposed in the paths of the platens of the inventive multi-baler system for detecting the arrivals of the platens at respective threshold positions. If a platen fails to reach a threshold position when forcibly lowered, the associated baling compartment is assumed full of crushed material and the preparation of a bound bale is preferred without further loading of the compartment. However, if the platen reaches or extends beyond its threshold position when forcibly extended, the baling compartment can receive more material before a bound bale is prepared. Accordingly, as shown in FIG. 13, the logical input 5 provides a signal indicative of whether the first platen has arrived at its threshold position according to a threshold sensor 30 (FIG. 4) functionally disposed in the path of the first platen 14. Similarly, the logical input 6 provides a signal indicative of whether the second platen 44 has arrived at its threshold position according to a threshold sensor 60 functionally disposed in the path of the second platen 44. The first and second platens in FIG. 1 are shown at or below their respective threshold positions.

The PLC 408 is provided many signals as shown in FIG. 13 and is capable of facilitating many advantages of the multi-baler system toward safety, toward automated functions, and toward dedicating the two baling compartments to the baling of different respective materials. Each power input of the PLC in FIG. 13, such as power input 1c, is disposed in electrical communication with its associated power output, such as power output 1, according to the PLC programming which functionally relies on the signals at the logical inputs as variables. The PLC may be programmed to assume any one of many particular programming configurations. Though the possible programming configurations are too numerous to describe them all, several exemplary programming configurations are described below.

In a first exemplary PLC programming configuration, the PLC 408 of FIG. 13 is programmed to arrest movements of a non-selected platen. In this first example, when a signal at the logical input 2 indicates selection of the first baler 10, power outputs 1 and 2 are denied causing the second director valve 206 of FIG. 7 to assume its neutral position such that movements of the second ram assembly are arrested. Similarly, when the second baler 40 is selected, power outputs 3 and 4 are denied causing movements of the first ram assembly to be arrested. Thus, according to this first example, the motor and pump are called upon to motivate movement of only one ram assembly at a time. This is beneficial with regard to avoiding the higher costs of motors and pumps having the capacities to motivate several ram assemblies at once. This also promotes safety by avoiding potential confusion that might otherwise occur if two platens move simultaneously. This furthermore is beneficial with regard to baling different types and different volumes of materials in the several balers of the inventive multi-baler system.

In a second exemplary PLC programming configuration, the PLC 408 of FIG. 13 is programmed to automate some movements of the first and second platens. This second example relates equally to the first and second balers, either of which may be exclusively selected by the Baler Selector switch. In this second example, when both the upper gate and the lower door of the selected baler are closed, a single press of the Down Button causes the PLC to invoke a timed extension of the selected baler. When the Down Button is pressed, a timer of the PLC initiates a time measurement toward a programmed or preset extension time interval. For the duration of the extension interval, the PLC permits power to the contactor 404 which energizes the motor 164 to drive the fluid pump 162. Concurrently, the PLC actuates the director valve of the selected baler to its extend position and allows the director valves of any non-selected balers to assume their neutral positions.

In particular, if the first baler is selected and the Down Button is pressed, the PLC permits power to the power output 3 to actuate the solenoid circuit 214 and denies power to the power output 4. This compels the first director valve 204 to assume its extend position 208. Furthermore, the PLC denies power to the power outputs 1 and 2 in order to allow the second director valve 206 to assume its neutral position 210. Conversely, if the second baler is selected and the Down Button is pressed, the PLC permits power output 1 and denies power outputs 2, 3, and 4 to dispose the first and second director valves into their neutral and extend positions respectively.

Thus, in this second exemplary PLC programming configuration, the selected baler extends its platen for the duration an extension interval when the down button is pressed. It is expected that downward movement of the selected platen will be stopped within the extension interval by either full extension of the selected ram assembly or by crushed material below the platen. The pressure relief apparatus 176 at least intermittently assumes its bypass position as shown in FIG. 8 during the remainder of the extension interval after the downward movement of the selected platen is stopped. During this remainder of time, the selected platen is maintained in a lowered position according to either full extension of the selected ram assembly or according to the level of crushed material within the selected baling compartment. The programmed or preset extension time interval is preferably selected to assure full extension of the ram assembly. As the multiple ram assemblies of the inventive multi-baler system may have different dimensions, capacities, and movement speeds under the influences of pressures from the fluid pump, different ram assemblies may be assigned different extension time intervals.

Furthermore, in this second exemplary PLC programming configuration, the lowered platen is automatically raised after expiration of the extension interval if further loading of the baling compartment is appropriate. That is, the PLC directs upward movement of the platen by withdrawing the ram assembly if the threshold sensor of the selected baler was actuated by downward movement of the platen during the extension interval. In particular, if the first platen is lowered and the logical input 5 of the PLC 408 (FIG. 13) indicates arrival of the first platen (FIG. 2) at its threshold position during the extension interval, subsequent to the expiration of the interval the PLC directs the platen to raise by permitting power output 4 and denying power output 3. Conversely, if the second platen is lowered and the logical input 6 indicates arrival of the platen at its threshold position during the extension interval, the PLC subsequently directs the platen to raise by permitting power output 2 and denying power output 1. In these situations, the PLC initiates a second time measurement toward a programmed or preset withdrawal time interval during which the selected platen is raised. At the end of the withdrawal interval, the PLC arrests movements of all platens by denying power outputs 1, 2, 3, and 4 and optionally turns off the motor by denying power output 5. The programmed or preset withdrawal time interval for each ram assembly is preferably selected to assure full withdrawal of the ram assembly. Withdrawal time intervals may be the same or may be different from extension time intervals for respective ram assemblies.

However, in this second exemplary PLC programming configuration, the lowered platen is arrested after expiration of the extension interval if the preparation of a bale is appropriate. That is, the PLC disposes the directed valve of the selected baler to assume its neutral position if the threshold sensor of the selected baler was actuated by downward movement of the platen during the extension interval. In particular, if the first platen is lowered and the logical input 5 of the PLC 408 (FIG. 13) fails to indicate arrival of the first platen (FIG. 2) at its threshold position during the extension interval, the PLC subsequently arrests the platen by denying power outputs 3 and 4. Conversely, if the second platen is lowered and the logical input 6 fails to indicate arrival of the platen at its threshold position during the extension interval, the PLC subsequently arrests the platen by denying power outputs 1 and 2. Concurrently, the PLC lights an indicator 426 by which the operator is informed that the preparation of a bound bale is appropriate. The indicator 426 may be disposed along the array 6 of FIGS. 1 and 2 for convenient observance by an operator. The platen is maintained in its lowered position as an operator opens the lower door of the selected baler and prepares a bound bale. The operator subsequently resets the selected baler by pressing and holding the Up Button according to the fifth exemplary PLC programming configuration as described herein.

Regarding nominal dimensions of prepared bales, the nominal length and the nominal width for a bale prepared in a particular baler are expected to respectively correspond to the length and the width of the platen of the particular baler. A nominal height for a bale prepared in a particular baler is generally prescribed by the threshold position of the platen of the particular baler according to the placement of the respective threshold sensor. Thus, the nominal height of a bale prepared in the first baler 10 (FIG. 1) generally corresponds to the distance 28 between the first platen 14 and the first floor 16 when the platen is disposed at its threshold position according to the placement of the threshold sensor 30 (FIG. 4) relative to the first floor. The nominal height of a bale prepared in the second baler 40 (FIG. 1) generally corresponds to the distance 58 between the second platen 44 and the second floor 46 when the platen is disposed at its threshold position according to the placement of the threshold sensor 60 (FIG. 4) relative to the second floor. Actual dimensions of bales prepared and removed from balers may vary somewhat from the nominal dimensions described here according to the degrees to which the balers are filled with material when bales are prepared. For example, if an excessive amount of material is deposited into a baler, the actual height of a bale subsequently prepared may exceed the height of the threshold position of that baler. Furthermore, an operator may dispose and arrest the platens at arbitrary positions between fully withdrawn and fully extended positions according to the fifth exemplary PLC programming configuration described herein, therefore bales may be prepared to have arbitrary heights that differ from the nominal heights of bales prepared according to the second exemplary PLC programming configuration described herein.

In a third exemplary PLC programming configuration, the PLC 408 is programmed to prevent unexpected movements of the platens when the E-Stop button 430 is reset after being pressed. Because the E-Stop button in FIG. 13, is electrically disposed between the transformer and the line 422, all ram assemblies are arrested and the motor is stopped when the E-Stop button is pressed. Thus, movements such as timed extensions and timed withdrawals that are underway according to other programming configurations of the PLC are arrested by pressing the E-Stop button. Power is restored to the line 422 when the E-Stop button is reset. However, in the third exemplary PLC programming configuration, when the E-Stop button is reset the PLC does not merely continue platen movements that were underway at the time the button was pressed. Power to the PLC along the line 420 is maintained as the E-Stop button interrupts and restores power to the line 422. Thus, the PLC remains active when an operator invokes an emergency stop of the baler system. By way of the logical input 1, the PLC receives signals indicating the status of the E-Stop button as the button is pressed and reset. In this third example, after the E-Stop button is pressed and reset, the PLC maintains the arrest of the platens and the motor until at least a baler is selected and either of the Up Button 434 and the Down Button 436 is pushed. Optionally, the E-Stop button may provide a safety lock-out feature such that a key is required to reset the button once depressed. The E-Stop button may be disposed along the array 6 of FIGS. 1 and 2 for convenient access by an operator.

A fourth exemplary PLC programming configuration relates to both the first and second platens according the tentative disposition Baler Selector switch. In the fourth example, the PLC is programmed to arrest timed movements of the platen of the selected baler if either of the lower door and the upper gate of the selected baler is manually opened at any time during an extension or withdrawal interval. Any opening of either of the second lower door and second upper gate constitutes a manual opening and is indicated by a signal at the logical input 4. Any opening of the first lower door constitutes a manual opening and is indicated by a signal at the logical input 3 when the first lower door is opened. The first upper gate, however, is automatically opened by the rising first platen during the automated withdrawal protocol of the first platen. This automatic opening of the first gate can be discerned by the PLC from a manual opening according to the signals at the logical input 9 and the logical input A. As an automatic opening of the first gate occurs, signals at the logical input 9 and the logical input A indicate in concert that the rising first platen is opening the gate. A manual opening of the first gate, however, occurs without a signal at the logical input A indicating that the rising first platen is causing the first gate to open. Thus, in the fourth example, the PLC 408 is programmed to discern manual openings of the doors and gates and to arrest automated movements when such openings occur.

In a fifth exemplary PLC programming configuration, automated movements of the platens are discontinued as a safety advantage upon any manual opening of a door or gate of the moving platen as in the fourth exemplary PLC programming previously described. However, in this fifth example the PLC is programmed to allow this safety advantage to be over-ridden when the Up Button is pressed and manually held pressed. Thus, even with a door and gate opened, the platen of the selected baler can be raised by holding the Up Button in a pressed or otherwise actuated disposition. This over-ride capability is useful, for example, when a wrapped bale is to be ejected though the open door by a cable or other member for the convenience of an operator as the platen is raised by holding the Up-Button pressed.

This over-ride capability does not extend to the lowering of the platens in this fifth example of PLC programming. In this fifth example, a platen simply cannot be lowered if closure is lost by either of the associated upper gate and lower door. Nonetheless, another exemplary PLC programming configuration differs with the fifth example in that the PLC provokes both raising and lowering of the platen of the selected baler when the Up Button and Down Button are respectively held pressed even though all gates and doors may be open.

Except where explicitly indicated, the descriptions herein of the balers of the inventive multi-baler system are generic with regard to absolute and relative dimensions and volume capacities and with regard what types of materials may be baled within the respective balers. Nonetheless, a particular embodiment of the multi-baler system, and particular distinctions of that embodiment, will now be described. It should be understood that such descriptions of a particular embodiment cannot be construed to export limitations to other descriptions herein.

A particular embodiment of the multi-baler system 5 is constructed and configured for the baling of cardboard material in the first baler 10 and for the baling of plastic in the second baler 40. In that embodiment, the second platen 44 is dimensionally smaller than the first platen 14. It is expected that a bale of crushed plastic material may be inconveniently heavy if the bale is prepared to dimensions that are typical for cardboard bales. Therefore, in this particular embodiment, some smaller dimensions are preferred for the second baler so that dimensionally smaller plastic bales can be prepared and transported.

In particular, the second baler 40 may be dimensioned to prepare plastic bales that are shaped as cubes with side dimensions of twenty four inches. Such cube-shaped plastic bales may weigh seventy five pounds or less upon preparation and can be conveniently stacked with four cubes per stack-layer on a conventional wooden shipping pallet. In this particular embodiment of the multi-baler system 10, the surface area of the first platen is preferably greater than the surface area of the second platen, due at least in part to the greater length 24 of the first platen relative to the length 54 of the second platen as viewed in FIG. 2. Furthermore, in this particular embodiment, the nominal height of a bale prepared in the first baler is generally greater than the nominal height of a baler prepared in the second baler, insofar as the bales are prepared according to the second exemplary PLC programming configuration. That is, in this particular embodiment, when both movable platens are disposed at their threshold positions, the distance 28 is greater than the distance 58. For example, the distance 28 may be several feet and the distance 58 may be approximately twenty four inches when the movable platens assume their respective threshold positions.

Furthermore, in this particular embodiment, air is expected to readily escape porous materials within the first baler as the first platen is lowered. However, the second baler 40 is directed toward the baling of plastic materials that may tend to at least temporarily trap air between film layers or within plastic bags and the like. Trapped air may be readily volumetrically reduced as a platen is lowered only to re-expand as the platen is raised. Therefore the second baler is configured to bring the second platen 44 relatively close to the second floor 46 upon full extension of the second ram assembly in order to cause air-trapping layers and bags and the like to pop and expel their air contents. For example, the second baler may be configured to have a threshold position for the second platen that brings the distance 58 (FIG. 2) to approximately twenty four inches, and a full extension position for the second platen that brings the distance 58 to a value that is less than several inches, and is optionally less than one inch, and is optionally approximately one half of one inch. Furthermore, the second baler may be configured to bring the second movable platen 44 into contact with the floor 46 upon full extension of the second ram assembly. On the other hand, the full extension position of the first movable platen may bring the distance 28 to several feet, for example four feet, and the threshold position for the first platen may be several inches, or less, above the full extension position thereof.

Furthermore yet, in this particular embodiment, the programmed or preset extension interval for the second ram assembly may be selected to exceed the expected time for full extension to permit time for air to escape plastic materials crushed by the lowered platen. Recall that as a lowering platen is arrested by crushed material at least partially filling a baling compartment, the PLC of the inventive baler system maintains the platen in its lowered position at least until the duration of the extension interval passes, according to the second PLC programming configuration described herein. The extension interval may be selected to be several seconds longer than the known or expected time for full extension of the ram assembly. For example, if the second ram assembly typically fully extends in twenty seconds, the extension interval for the second ram assembly may be programmed or preset to be twenty-two seconds or longer.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A multiple baler system comprising:
a first ram assembly comprising a first cylinder and a first ram shaft movably engaged by the first cylinder, wherein the first cylinder is capable of forcibly moving the first ram shaft upon receipt of pressurized fluid by the first cylinder;
a second ram assembly comprising a second cylinder and a second ram shaft movably engaged by the second cylinder, wherein the second cylinder is capable of forcibly moving the second ram shaft upon receipt of pressurized fluid by the second cylinder;
a fluid pump capable of providing pressurized fluid;
a motor coupled to the fluid pump, the motor capable of motivating the fluid pump to provide pressurized fluid;
a fluid manifold system disposed in fluid communication with the first ram assembly, the second ram assembly, and the fluid pump, the fluid manifold system capable of disposing the fluid pump into fluid communication with the first ram assembly and second ram assembly;
one or more control switches capable of receiving one or more user actions for exclusively selecting either one of the first ram assembly and second ram assembly, and for prompting movement of the ram assembly selected;
a controller disposed in electrical communication with the fluid manifold system, the motor, and the one or more control switches, the controller configured to actuate the fluid manifold system to dispose the fluid pump into fluid communication with the selected ram assembly responsively to the one or more user actions, the controller further configured to activate the motor to motivate the fluid pump to provide pressurized fluid for at least one predetermined time interval responsively to the one or more user actions.

2. The multiple baler system of claim 1, further comprising a pressure relief device disposed in fluid communication with the fluid pump and the fluid manifold system, the pressure relief device permitting pressurized fluid provided by the fluid pump to by-pass at least the selected ram assembly after movement of the selected ram assembly during the at least one predetermined time interval.

3. The multiple baler system of claim 2, wherein the first cylinder is capable of extending the first ram shaft to a full extension beyond which further extension is prevented by the engagement of the first ram shaft with the first cylinder, wherein the second cylinder is capable of extending the second ram shaft to a full extension beyond which further extension is prevented by the engagement of the second ram shaft with the second cylinder, wherein the ram shaft of the selected ram assembly is extended to full extension during the at least one predetermined time interval, and wherein the pressure relief device permits pressurized fluid to by-pass at least the selected ram assembly for the remainder of the at least one predetermined time interval after the ram shaft of the selected ram assembly is extended to full extension.

4. The multiple baler system of claim 1, further comprising:
a first movable platen attached to and movable with the first ram shaft;
a first fixed platen opposing the first movable platen;
a second movable platen attached to and movable with the second ram shaft; and
a second fixed platen opposing the second movable platen,
wherein the first cylinder is capable of extending the first ram shaft to a full extension beyond which further extension is prevented by the engagement of the first ram shaft with the first cylinder,
wherein the first movable platen is disposed a first distance from the first fixed platen when the first ram shaft is extended to full extension,
wherein the second cylinder is capable of extending the second ram shaft to a full extension beyond which further extension is prevented by the engagement of the second ram shaft with the second cylinder,
wherein the second movable platen is disposed a second distance from the second fixed platen when the second ram shaft is extended to full extension, and
wherein the first distance is greater than the second distance.

5. The multiple baler system of claim 4, wherein the first distance is greater than two linear feet and wherein the second distance is less than one linear foot.

6. The multiple baler system of claim 4, wherein the first distance is greater than two linear feet and wherein the second distance is less than six linear inches.

7. The multiple baler system of claim 1, wherein the controller comprises a programmable logic controller configured to measure the predetermined time interval.

8. The multiple baler system of claim 1, wherein the fluid manifold system comprises:
a first valve disposed in fluid communication with the fluid pump and the first ram assembly, the first valve capable of assuming a neutral position and one or more additional positions, wherein the first valve prevents fluid communication between the fluid pump and the first ram assembly when the first valve assumes the neutral position thereof; and
a second valve disposed in fluid communication with the first valve and the second ram assembly with the first valve disposed between the fluid pump and the second valve, the second valve capable of assuming a neutral position and one or more additional positions, wherein the second valve prevents fluid communication between the first valve and the second ram assembly when the second valve assumes the neutral position thereof.

9. The multiple baler system of claim 8, wherein the first valve disposes the fluid pump into fluid communication with the second valve when the first valve assumes the neutral position thereof.

10. The multiple baler system of claim 8, wherein the controller is configured prevent the first valve and second valve from simultaneously leaving their neutral positions in order to prevent simultaneous movements of the first and second ram shafts.

11. The multiple baler system of claim 8, wherein the controller is disposed in electrical communication with the first valve and the second valve, and wherein the controller is configured to maintain the second valve in the neutral position thereof when the first ram assembly is selected by one or more user actions, and wherein the controller is configured to maintain the first valve in the neutral position thereof when the second ram assembly is selected by one or more user actions.

12. A multiple baler system comprising:
a first baler comprising a first fixed platen, a first movable platen movably opposing the first fixed platen, and a first ram assembly attached to the first movable platen, the first ram assembly capable of forcibly extending the first movable platen toward the first fixed platen;
a second baler comprising a second fixed platen, a second movable platen movably opposing the second fixed platen, and a second ram assembly attached to the second movable platen, the second ram assembly capable of forcibly extending the second movable platen toward the second fixed platen; and
a control system linked to each of the first ram assembly and second ram assembly, the control system comprising a motor capable of motivating the first ram assembly to forcibly extend the first movable platen and capable of motivating the second ram assembly to forcibly extend the second movable platen.

13. The multiple baler system of claim 12, wherein the first movable platen is vertically disposed above the first fixed platen such that a distance therebetween is vertically diminished when the first movable platen is forcibly extended toward the first fixed platen.

14. The multiple baler system of claim 12, wherein when material is entered into the first baler for baling of the material, the material directly abuts the first fixed platen.

15. The multiple baler system of claim 12, wherein the control system is configured to motivate one of the first ram assembly and second ram assembly at a time and to prevent simultaneous movements of the first movable platen and second movable platen.

16. The multiple baler system of claim 12, further comprising a programmable logic controller disposed in electrical communication with the control system.

17. The multiple baler system of claim 12, wherein the first movable platen and the second movable platen each have a respective surface area for abutting material to be baled, and wherein the surface area of the first movable platen is greater than the surface area of the second movable platen.

18. The multiple baler system of claim 12, wherein the control system comprises a control switch for actuation by a user, and wherein the control system is configured to motivate one of said ram assemblies for a particular time interval upon actuation of the button.

19. The multiple baler system of claim 12, wherein:
the first ram assembly is capable of reaching full extension beyond which further extension is prevented by the construction of the first ram assembly;
the first movable platen is disposed a first distance from the first fixed platen when the first ram assembly reaches full extension;
the second ram assembly is capable of reaching full extension beyond which further extension is prevented by the construction of the second ram assembly;
the second movable platen is disposed a second distance from the second fixed platen when the second ram assembly reaches full extension; and
the first distance is greater than the second distance.

20. The multiple baler system of claim 12, wherein the control system is configured to motivate the second ram assembly to extend for a predetermined interval of time that is greater than an amount of time needed for the second ram assembly to reach full extension.
